(19) United States
(12) Patent Application Publication
(10) Pub. No.: US 2026/0326384 A1
(43) Pub. Date: Oct. 22, 2026

(54) HEIGHT COMPENSATION METHOD AND APPARATUS, COMPUTER DEVICE, AND STORAGE MEDIUM

(71) Applicant: SHENZHEN CREALITY 3D TECHNOLOGY CO., LTD., Shenzhen, Guangdong (CN)

(72) Inventors: Jingke TANG, Shenzhen (CN); Yulong WANG, Shenzhen (CN)

(21) Appl. No.: 19/103,492

(22) PCT Filed: Jun. 23, 2023
(86) PCT No.: PCT/CN2023/102998

§ 371 Date: Feb. 12, 2025

(30) Foreign Application Priority Data
Aug. 12, 2022 (CN) 202210968330.4

(51) Int. Cl. B29C 64/393; B33Y 50/02

(52) U.S. Cl. CPC B29C 64/393; B33Y 50/02

(57) ABSTRACT

A height compensation method, executed by a computer device, and comprising: when a nozzle is controlled to spray a first-layer printing material along a printing platform and to perform mobile sampling, obtaining a sampling result; performing data fusion processing on a first measured pressure value and a second measured pressure value to obtain a true pressure value at a current sampling moment; obtaining a compensation model between a pressure value and a height compensation value, and determining, according to the compensation model, a target height compensation value corresponding to the true pressure value; and according to the target height compensation value, compensating an initial height value, which is acquired at the current sampling moment, between the nozzle and the printing platform.

### CROSS-REFERENCE TO RELATED APPLICATION

This application claims priority to Chinese Patent Application No. 202210968330.4, filed with the China National Intellectual Property Administration and entitled “Height Compensation Method and Apparatus, Computer Device, and Storage Medium” on Aug. 12, 2022, which is incorporated herein by reference in its entirety.

### TECHNICAL FIELD

The present disclosure relates to the field of 3D printing technology, particularly to a height compensation method and apparatus, a computer device, and a storage medium.

### BACKGROUND

3D printing is a rapid prototyping technology that uses digital model files as the basis and uses special wax materials, powdered metals or plastics and other bondable materials to construct three-dimensional entities by printing layer by layer. How to ensure the horizontality of the printing material on the printing platform is the focus of current research.

Currently, when a measuring point on the printing platform is measured, it is necessary to predetermine a plurality of adjacent points in an adjacent area of the measuring point, construct a fitting plane through coordinate data of the adjacent points, and then calculate a height compensation value corresponding to the measuring point according to the fitting plane. However, since the spraying of the printing materials is a real-time and dynamic process, if the printing platform vibrates slightly but the height compensation value is still determined by the coordinate data of the adjacent points, it may cause a calculation error of the height compensation value. Accordingly, how to perform a real-time height compensation in the process of spraying the printing materials and ensure the accuracy of the height compensation is a problem to be addressed by the present disclosure.

### SUMMARY

According to the embodiments of the present disclosure, for the above technical problem, it is necessary to provide a height compensation method and apparatus, a computer device, a computer-readable storage medium, and a computer program product capable of improving the accuracy of the height compensation.

In the first aspect of the present disclosure, a height compensation method is provided, which is performed by a computer device, and the method may include:
acquiring a sampling result when a nozzle is controlled to spray a first layer of printing material along a printing platform and perform mobile sampling, wherein the sampling result comprises a first measured pressure value between the nozzle and the first layer of printing material, a second measured pressure value between the printing platform and the first layer of printing material, and an initial height value between the nozzle and the printing platform collected at a current sampling moment;
performing data fusion processing on the first measured pressure value and the second measured pressure value, and obtaining an actual pressure value at the current sampling moment;
acquiring a compensation model between a pressure value and a height compensation value;
determining a target height compensation value corresponding to the actual pressure value according to the compensation model; and
compensating for the initial height value between the nozzle and the printing platform collected at the current sampling moment according to the target height compensation value.

In another aspect of the present disclosure, a height compensation apparatus is provided, including:
a mobile sampling module, configured to acquire a sampling result when a nozzle is controlled to spray a first layer of printing material along a printing platform and perform mobile sampling, wherein the sampling result comprises a first measured pressure value between the nozzle and the first layer of printing material, a second measured pressure value between the printing platform and the first layer of printing material, and an initial height value between the nozzle and the printing platform collected at a current sampling moment;
a data fusion module, configured to perform data fusion processing on the first measured pressure value and the second measured pressure value, and obtain an actual pressure value at the current sampling moment;
a compensation value determination module, configured to acquire a compensation model between a pressure value and a height compensation value, determine a target height compensation value corresponding to the actual pressure value according to the compensation model, and compensate for the initial height value between the nozzle and the printing platform collected at the current sampling moment according to the target height compensation value.

In another aspect of the present disclosure, a computer device is provided, including one or more processors and a memory storing computer-readable instructions. The one or more processors, when executing the computer-readable instructions, may implement the steps in the method of any of the embodiments.

In another aspect of the present disclosure, one or more computer-readable storage media are provided, on which computer-readable instructions are stored. The computer-readable instructions, when executed by one or more processors, may cause the one or more processors to implement the steps in the method of any of the embodiments.

In another aspect of the present disclosure, a computer program product is provided, including computer-readable instructions. The computer-readable instructions, when executed by one or more processors, may cause the one or more processors to implement the steps in the method of any of the embodiments.

The details of one or more embodiments of the present disclosure are set forth in the accompanying drawings and the description below. Other features, purposes, and advantages of the present disclosure will be obvious from the specification, drawings, and claims.

### BRIEF DESCRIPTION OF THE DRAWINGS

In order to more clearly illustrate the technical solution in the embodiments of the present disclosure or in the conventional technology, accompanying drawings required for the descriptions of the embodiments or the conventional technology are briefly introduced below. Obviously, the drawings described below are merely embodiments of the present disclosure, and those skilled in the art can obtain other drawings based on the disclosed drawings without paying any creative work.

FIG. 1 is an application environment diagram of a height compensation method according to an embodiment.

FIG. 2 is a flow chart showing a height compensation method according to an embodiment.

FIG. 3 is a schematic structure diagram of a printing platform according to an embodiment.

FIG. 4 is a flow chart showing a height compensation method according to another embodiment.

FIG. 5 is a schematic distribution diagram of measuring points on a printing platform according to an embodiment.

FIG. 6 is a schematic distribution diagram of adjacent areas according to an embodiment.

FIG. 7 is a structure diagram illustrating a height compensation apparatus according to an embodiment.

FIG. 8 is a schematic diagram of an internal structure of a computer device according to an embodiment.

### DETAILED DESCRIPTION OF THE EMBODIMENTS

The technical solution in the embodiments of the present disclosure will be clearly and completely described below in conjunction with the drawings in the embodiments of the present disclosure. Obviously, the described embodiments are merely some embodiments of the present disclosure, rather than all of the embodiments. Based on the embodiments in the present disclosure, all other embodiments obtained by those skilled in the art without any creative work shall fall within the scope of protection of the present disclosure.

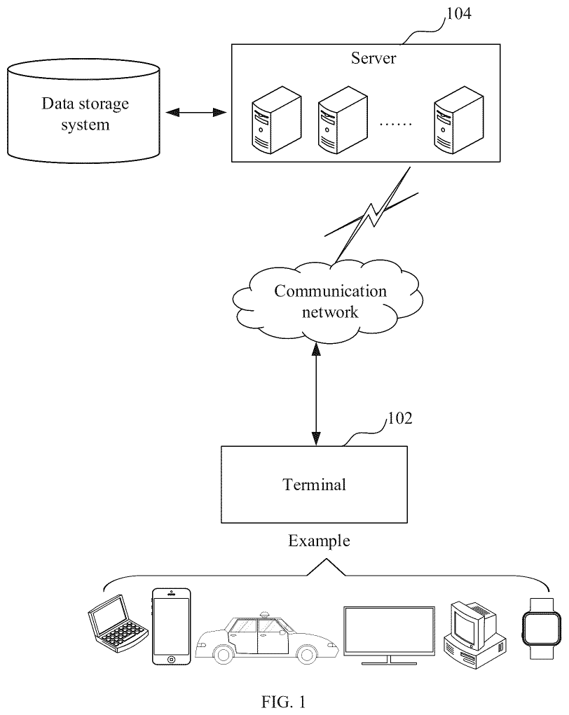

In an embodiment of the present disclosure, a height compensation method is provided, which can be applied in the application environment as shown in FIG. 1. A terminal 102 is in communication with a server 104 via a network. A data storage system can store data that the server 104 needs to process. The data storage system may be integrated on the server 104 or placed on a cloud or other network servers. Terminal 102 is configured to generate a sampling result when controlling a nozzle to spray a first layer of printing material along a printing platform and perform mobile sampling, and transmit the sampling result to the server 104. The server 104 is configured to perform data fusion processing on a first measured pressure value and a second measured pressure value in the sampling result and obtain an actual pressure value at the current sampling moment. The server 104 is further configured to acquire a compensation model between the pressure value and the height compensation value, and determine a target height compensation value corresponding to the actual pressure value according to the compensation model. An initial height value between the nozzle and the printing platform collected at the current sampling moment is compensated according to the target height compensation value. The terminal 102 may be, but is not limited to, various personal computers, 3D printers, laptop computers, smart phones, tablet computers, Internet of Things devices, and portable wearable devices. The server 104 may be implemented as an independent server or a server cluster consisting of multiple servers.

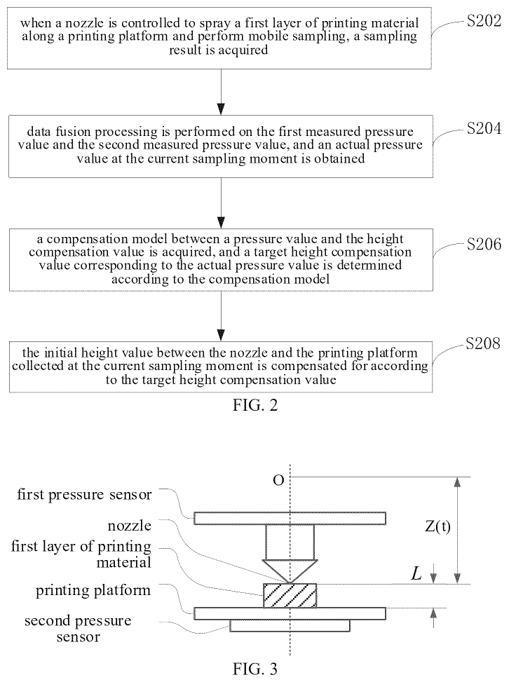

In an embodiment, as shown in FIG. 2, a height compensation method is provided, and the method is applied to a computer device as an example for illustration. The computer device may be the terminal or the server in the FIG. 1, and the method may include the following steps.

Step S202: when a nozzle is controlled to spray a first layer of printing material along a printing platform and perform mobile sampling, a sampling result is acquired.

The sampling result includes a first measured pressure value between the nozzle and the first layer of printing material, a second measured pressure value between the printing platform and the first layer of printing material, and an initial height value between the nozzle and the printing platform collected at a current sampling moment. The first layer of printing material is a printing material that is in direct contact with the printing platform.

The printing platform is a platform in a 3D printer for carrying a three-dimensional entity. When being in contact with a plane of the printing platform, a print head can move and sample at a preset frequency, and spray the printing material while moving. The print head may be a device including a nozzle and a pressure sensor, as shown in FIG. 3 which is a schematic structure diagram of the printing platform.

In an embodiment, when a user needs to perform a 3D printing task, the nozzle is first controlled to contact a measuring point on the printing platform, and then after being lifted to a certain height, the print head of the 3D printer is triggered to move parallel to the printing platform and spray the printing material according to a preset measurement frequency. That is, when the measurement frequency is f, a sampling time interval T for the nozzle to move and sample satisfies T=1/f. Accordingly, the sampling results corresponding to different sampling moments can be obtained. An X-coordinate and a Y-coordinate of the nozzle can be known according to a distance that the nozzle moves along the printing platform, and then the initial height value between the nozzle and the printing platform can be determined from a printing file. The pressure sensor on the print head can detect the first measured pressure value between the nozzle and the first layer of printing material. If the current sampling moment is regarded as the moment t, the first measured pressure value is p1(t), the second measured pressure value is p2(t), and the initial height value is Z(t).

In an embodiment, the first measured pressure value is detected by a first pressure sensor, and the second measured pressure value is detected by a second pressure sensor. The first pressure sensor is mounted on the nozzle, and the second pressure sensor is mounted on the printing platform.

In an embodiment, when the nozzle sprays the first layer of printing material, the nozzle and the first layer of printing material are in an extrusion state, and the material in the consumable roll may be pulled during the movement of the nozzle. Accordingly, the first measured pressure value may include a first extrusion force on the nozzle applied by the first layer of printing material, and a pulling force of the material on the nozzle. The second measured pressure value may include a second extrusion force on the printing platform applied the first layer of printing material, and a gravity of the first layer of printing material. The pulling force and the gravity can be regarded as an interference signal, and the first extrusion force and the second extrusion force are regarded as a valid signal.

In an embodiment, the computer device can determine a minimum sampling time interval Tₘᵢₙ when the nozzle moves, and Tₘᵢₙ can be determined according to a size of the printing platform, a maximum inclination angle of the printing platform, a printing speed of the nozzle in the Z-direction, etc.

Step S204: data fusion processing is performed on the first measured pressure value and the second measured pressure value, and an actual pressure value at the current sampling moment is obtained.

The method for performing the data fusion processing can be at least one of Bayesian criterion, Kalman filtering algorithm, D-S evidence theory, fuzzy set theory, artificial neural network, and machine learning.

In an embodiment, since random errors may occur when the nozzle is just controlled to move along the printing platform for sampling, part of the data initially sampled in the sampling result may be removed to ensure the accuracy of the actual pressure value obtained through the data fusion processing.

Step S206: a compensation model between a pressure value and the height compensation value is acquired, and a target height compensation value corresponding to the actual pressure value is determined according to the compensation model.

The compensation model can be a closed-loop control model, that is, a control mode in which a correction is performed according to output feedback of a controlled object. When an actual quantity measured deviates from a planned quantity, an adaptive regulation is performed according to a standard quantity, such as the Proportion Integral Differential (PID) model.

In an embodiment, the computer device can acquire a preset compensation model and a preset pressure threshold from a model library. The preset compensation model represents that settings of multiple model parameters are completed. Accordingly, the computer device can determine the target height compensation value according to the actual pressure value and the preset pressure threshold, that is, the actual pressure value and the preset pressure threshold are substituted into the compensation model, and the target height compensation value is obtained.

In an embodiment, the computer device predetermines a material height L formed when the nozzle is controlled to spray the first layer of printing material, as shown in FIG. 3, and sets a preset pressure threshold corresponding to the material height in advance according to different material heights.

In an embodiment, the step of determining the target height compensation value corresponding to the actual pressure value according to the compensation model may include: a historical actual pressure value at a previous sampling moment is determined; a first difference value between the actual pressure value and the preset pressure threshold is determined, and a second difference value between the historical actual pressure value and the preset pressure threshold is determined; the target height compensation value corresponding to the actual pressure value is determined according to the first difference value, the second difference value, and the compensation model.

The preset pressure threshold represents an expected pressure value applied on the nozzle by the first layer of printing material under an ideal condition when the height of the printing material is equal to L.

In an embodiment, since the mobile sampling of the nozzle is a dynamic closed-loop control process, the computer device can determine the historical actual pressure value at the previous sampling moment, which is obtained by performing the data fusion processing on the first measured pressure value at the previous sampling moment and the second measured pressure value at the previous sampling moment. The computer device determines the first difference value between the actual pressure value and the preset pressure threshold, and the second difference value between the historical actual pressure value and the preset pressure threshold, respectively. For example, the actual pressure value is p(1), the historical actual pressure value is p(t−1), and the preset pressure threshold is P, then the first difference value e(t) satisfies e(t)=p(t)−P, and the second difference value e(t−1) satisfies e(t−1)=p(t−1)−P. The computer device substitutes the first difference value and the second difference value into the compensation model to determine the target height compensation value corresponding to the actual pressure value, for example, the target height compensation value is z(t).

Step S208: the initial height value between the nozzle and the printing platform collected at the current sampling moment is compensated according to the target height compensation value.

In an embodiment, referring to FIG. 3, the point 0 refers to a zero point preset by the user, Z at the zero point is equal to 0, and the initial height value between the nozzle and the printing platform is a vertical height of a position to which the nozzle moves relative to the zero point which is set in the printing file. Under the ideal condition such as when the printing platform is completely flat, when the nozzle moves and samples the first layer of printing material, a vertical height of a position corresponding to each sampling moment relative to the zero point should be the same, that is, the initial height value should be the same, which is Z(t) in the figure. However, due to the unevenness of the printing platform, Z(t) may change with the actual pressure values corresponding to different sampling moments. That is, it is required to compensate for the initial height value of the corresponding sampling moment through the target height compensation value corresponding to the actual pressure value. For example, if a tiny protrusion occurs on the printing platform, it is required to determine the difference value between the initial height value and the corresponding target height compensation value, that is, to perform Z(t)-z(t) to implement the height compensation.

In an embodiment, the target height compensation value is configured to compensate for the initial height value of the position at the current sampling moment. However, since the nozzle is always in the process of moving and sampling, the target height compensation value may complete the compensation between the current sampling moment and the next sampling moment.

In an embodiment, the sampling time interval T for triggering the nozzle to perform the mobile sampling needs to be greater than or equal to the minimum sampling time interval Tₘᵢₙ, which can ensure that the target height compensation value completes the compensation between the current sampling moment and the next sampling moment.

In the above-mentioned height compensation method, when the nozzle is controlled to spray the first layer of printing material along the printing platform and perform the mobile sampling, the sampling result is acquired; the sampling result includes the first measured pressure value between the nozzle and the first layer of printing material, the second measured pressure value between the printing platform and the first layer of printing material, and the initial height value between the nozzle and the printing platform collected at the current sampling moment; the data fusion processing is performed on the first measured pressure value and the second measured pressure value to obtain the actual pressure value at the current sampling moment; the compensation model between the pressure value and the height compensation value is acquired, and the target height compensation value corresponding to the actual pressure value is determined according to the compensation model; the initial height value between the nozzle and the printing platform collected at the current sampling moment is compensated for according to the target height compensation value. Since in the present disclosure, the actual pressure value at the current sampling moment is determined in real time during the mobile sampling of the nozzle, and then the target height compensation value corresponding to the actual pressure value at the current sampling moment is determined through the compensation model. Compared to the conventional mode in which the coordinate data of multiple adjacent points needs to be predetermined, in the present disclosure there is no need to adjust the printing platform before the mobile sampling of the nozzle, and the height compensation values for different sampling positions can be accurately determined in real time during the spraying of the printing material, thereby avoiding the problem of unequal thickness of the sprayed printing material when the moving of the nozzle is not absolutely parallel on the printing platform due to system errors or when the printing platform is uneven.

In an embodiment, the step of performing the data fusion processing on the first measured pressure value and the second measured pressure value to obtain the actual pressure value at the current sampling moment may include: the data fusion processing is performed on the first measured pressure value and the second measured pressure value by using a Kalman filter algorithm, and the actual pressure value at the current sampling moment is obtained.

The Kalman filter algorithm refers to accurately obtaining an actual value at a current sampling moment through a measured value at the current sampling moment and an estimated value at the previous sampling moment.

In the embodiment, the data fusion processing is performed through the Kalman filter algorithm, which not only implements a weighted fusion of the first measured pressure value and the second measured pressure value, but also completes recursion of a stress state of the printing material from the previous sampling moment to the current sampling moment, and accurately obtains the actual value at the current sampling moment, thereby obtaining a global optimal estimation and ensuring the accuracy of the actual pressure value when the nozzle is sampling.

In an embodiment, the step of determining the target height compensation value corresponding to the actual pressure value is determined according to the first difference value, the second difference value and the compensation model may include: the first difference value is substituted into a proportional sub-model to obtain a first height compensation value; a second height compensation value is obtained according to the first difference value and an integral sub-model; the first difference value and the second difference value are substituted into a differential sub-model to obtain a third height compensation value; and the first height compensation value, the second height compensation value, and the third height compensation value are superimposed to obtain the target height compensation value.

The compensation model may be a positional PID model, and include a proportional sub-model, an integral sub-model and a differential sub-model, for example:

$$z ( t ) = {K}_{P} e ( t ) + {K}_{I} {\sum }_{t = n}^{n + m} e ( t ) + {K}_{D} [ e ( t ) - e ( t - 1 ) ] ( n ∈ [ 0 , ∞ )$$

where K_{P} represents a proportional control parameter in the proportional sub-model, Ky represents an integral control parameter in the integral sub-model, M represents an integral depth parameter in the integral sub-model, and K_{D} represents a differential control parameter in the differential sub-model. Referring to the above description, e(t) represents the first difference value, and e(t−1) represents the second difference value.

In an embodiment, the computer device obtains the first height compensation value according to the first difference value and the proportional sub-model, and substitutes the first difference value into the integral sub-model to obtain the second height compensation value. The computer device determines the third difference value between the first difference value and the second difference value, and substitutes the third difference value into the differential sub-model to obtain the third height compensation value, so that the target height compensation value is obtained according to the first height compensation value, the second height compensation value and the third height compensation value. Accordingly, in the embodiment the target height compensation value at the current sampling moment can be quickly determined through the positional PID model, thereby improving the efficiency of data processing.

In an embodiment, the step of superimposing the first height compensation value, the second height compensation value and the third height compensation value to obtain the target height compensation value may include: the first height compensation value, the second height compensation value and the third height compensation value are superimposed to obtain a candidate height compensation value; the candidate height compensation value is determined as the target height compensation value when a magnitude relationship between the preset compensation threshold and the candidate height compensation value satisfies a preset condition; the preset compensation threshold is determined as the target height compensation value when the magnitude relationship between the preset compensation threshold and the candidate height compensation value dissatisfies the preset condition.

The preset compensation threshold refers to a maximum dynamic compensation range e. Since a height difference value of a general printing platform is about 3 mm and the maximum height difference value is about 10 mm, the preset compensation thresholds are usually different for different models of 3D printers.

In an embodiment, if z(t) obtained by superimposing the first height compensation value, the second height compensation value and the third height compensation value is determined as the candidate height compensation value, it is required to compare the candidate height compensation value to the preset compensation threshold, that is, to determine whether the magnitude relationship between the preset compensation threshold and the candidate height compensation value satisfies the preset condition. If the candidate height compensation value is less than or equal to the preset compensation threshold, it can be regarded that the magnitude relationship between the preset compensation threshold and the candidate height compensation value satisfies the preset condition, and the candidate height compensation value serves as the target height compensation value. If the candidate height compensation value is greater than the preset compensation threshold, it can be regarded that the magnitude relationship between the preset compensation threshold and the candidate height compensation value dissatisfies the preset condition, and the preset compensation threshold serves as the target height compensation value.

In the embodiment, by determining whether the magnitude relationship between the preset compensation threshold and the candidate height compensation value satisfies the preset condition, the preset compensation threshold or the candidate height compensation value can be flexibly selected as the target height compensation value in different situations, thereby improving the accuracy of subsequent height compensation.

In an embodiment, when the nozzle is controlled to spray the first layer of printing material along the printing platform and perform the mobile sampling, the sampling results obtained may also include a nozzle motor current, a nozzle motor vibration frequency and the like. The target height compensation value may also be determined through a material blockage detector, an artificial intelligence camera, etc.

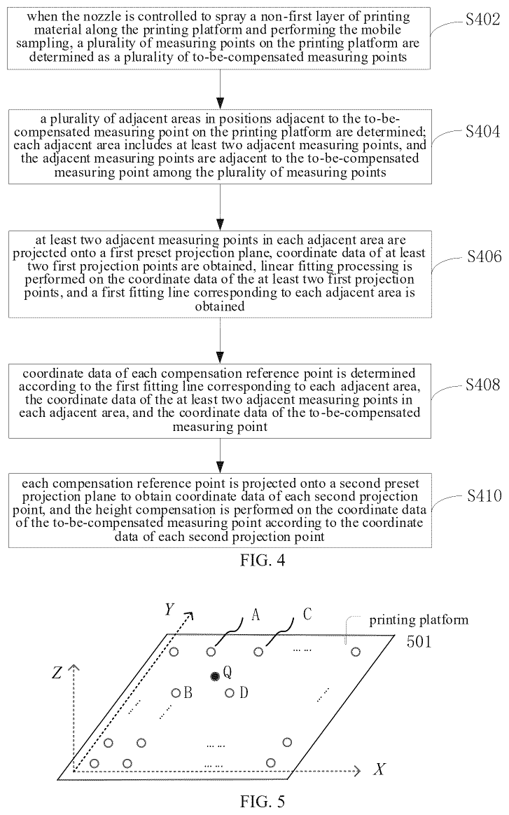

In an embodiment, as shown in FIG. 4, the height compensation method in the present disclosure may further include the following steps:

Step S402: when the nozzle is controlled to spray a non-first layer of printing material along the printing platform and perform the mobile sampling, a plurality of measuring points on the printing platform are determined as a plurality of to-be-compensated measuring points.

When the nozzle is controlled to spray the non-first layer of printing material along the printing platform and perform the mobile sampling, a detection unit on the print head can measure coordinate data corresponding to each measuring point on the printing platform. The non-first layer of printing material is continuously sprayed and superimposed on the first layer of printing material after the nozzle is controlled to completely spray the first layer of printing material. As shown in FIG. 5, FIG. 5 is a schematic distribution diagram of measuring points on the printing platform 501. The measuring points on the printing platform forms a matrix of m rows and n columns. The matrix is as follows:

$${A}_{m \times n} = [ \begin{matrix}{a}_{00} & {a}_{01} & … & {a}_{0 ( n - 1 )} \\ {a}_{10} & {a}_{11} & & {a}_{1 ( n - 1 )} \\ ⋮ & & ⋱ & ⋮ \\ {a}_{( m - 1 ) 0} & {a}_{( m - 1 ) 1} & … & {a}_{( m - 1 ) ( n - 1 )}\end{matrix} ] ( m , n ∈ [ 2 , ∞ ) )$$

where the coordinate data of the measuring points is denoted as

aᵢⱼ=(xᵢⱼ,yᵢⱼ,zᵢⱼ)(i∈[0,m−1],j∈(0,n−1).

In an embodiment, when the user continues to perform the 3D printing task based on the first layer of printing material, the print head of the 3D printer may be triggered to move. When the print head moves to a corresponding position on the printing platform, the detection unit on the print head can detect a to-be-compensated measuring point currently needing the height compensation, and transmit coordinate data of the to-be-compensated measuring point to the computer device.

In an embodiment, each measuring point in a plurality of measuring points corresponding to the current printing task is regarded as a to-be-compensated measuring point, in order to implement the height compensation for the to-be-compensated measuring point.

Step S404: a plurality of adjacent areas in positions adjacent to the to-be-compensated measuring point on the printing platform are determined, each adjacent area includes at least two adjacent measuring points, and the adjacent measuring points are adjacent to the to-be-compensated measuring point among the plurality of measuring points.

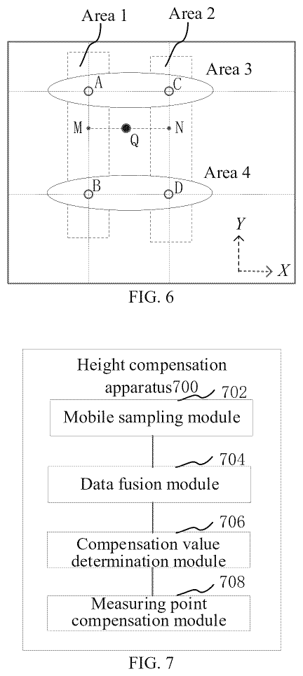

In an embodiment, the computer device may perform an adjacent area detection on the to-be-compensated measuring point, and adjacent areas in a preset direction are regarded as the adjacent areas corresponding to the to-be-compensated measuring point. The adjacent area in the preset direction may be determined according to a first preset projection plane. As shown in FIG. 6 for example, FIG. 6 is a schematic distribution diagram of adjacent areas on the printing platform, and the positions adjacent to the to-be-compensated measuring point Q include an area 1, an area 2, an area 3, and an area 4. When the first preset projection plane is the YZ plane, the adjacent areas in the preset direction include the area 1 and the area 2. When the first preset projection plane is an XZ plane, the adjacent areas in the preset direction include the area 3 and the area 4.

Furthermore, the computer device determines, for each adjacent area, an adjacent measuring point located in a current adjacent area of the to-be-compensated measuring point. Each adjacent area includes at least two adjacent measuring points, and the adjacent measuring points are selected from the measuring points, for example, the adjacent measuring points A and B in the area 1.

In an embodiment, the computer device acquires the adjacent measuring points in the positions adjacent to the to-be-compensated measuring point from a preset database according to the coordinate data of the to-be-compensated measuring point.

Step S406: at least two adjacent measuring points in each adjacent area are projected onto a first preset projection plane, coordinate data of at least two first projection points are obtained, linear fitting processing is performed on the coordinate data of the at least two first projection points, and a first fitting line corresponding to each adjacent area is obtained.

The first preset projection plane may be a projection plane preset by a user, such as a YZ plane in the three-dimensional coordinate system. Since the processing process for the at least two adjacent measuring points in each adjacent area is the same, in order to better describe the present disclosure, the process will be described below for at least two adjacent measuring points in any adjacent area.

In an embodiment, the computer device projects each of the at least two adjacent measuring points onto the first preset projection plane to obtain a first projection point corresponding to each adjacent measuring point, that is, a three-dimensional coordinate is transformed to a two-dimensional coordinate. For example, the adjacent measuring points A and B in the area 1 are projected onto the preset YZ plane to obtain first projection points a and b. The computer device performs the linear fitting processing on each first projection point to obtain a first fitting line corresponding to the first adjacent measuring points, that is, the linear fitting is performed on the first projection points a and b. The linear fitting method may be a least squares fitting method or the like, which is not limited here.

Step S408: coordinate data of each compensation reference point is determined according to the first fitting line corresponding to each adjacent area, the coordinate data of the at least two adjacent measuring points in each adjacent area, and the coordinate data of the to-be-compensated measuring point.

When there are two adjacent areas, there exist two first fitting lines, and the number of compensation reference points in each adjacent area is also determined to be two.

In an embodiment, the computer device determines whether horizontal coordinate data of the at least two adjacent measuring points in each adjacent area are the same. When the horizontal coordinate data of the at least two adjacent measuring points are the same, a first reference point determination model is acquired from the database, and the coordinate data of the at least two adjacent measuring points and the coordinate data of the to-be-compensated measuring point are substituted into the first reference point determination model to obtain coordinate data of a compensation reference point. When the horizontal coordinate data of the at least two adjacent measuring points are different, a second reference point determination model is acquired from the database, and the coordinate data of the at least two adjacent measuring points and the coordinate data of the to-be-compensated measuring point are substituted into the second reference point determination model to obtain the coordinate data of the compensation reference point. The first reference point determination model indicates that no coordinate transformation of the coordinate data of the adjacent measuring points is required. The second reference point determination model indicates that a right triangle needs to be constructed by using the coordinate data of the adjacent measuring points.

In an embodiment, the computer device may determine the coordinate data of each compensation reference point according to the first fitting line corresponding to each adjacent area and the coordinate data of the to-be-compensated measuring point.

Step S410: each compensation reference point is projected onto a second preset projection plane to obtain coordinate data of each second projection point, and the height compensation is performed on the coordinate data of the to-be-compensated measuring point according to the coordinate data of each second projection point.

The second preset projection plane has a different type from the first preset projection plane. For example, when the first preset projection plane is a YZ plane, the second preset projection plane is an XZ plane.

In an embodiment, the computer device projects each compensation reference point onto the second preset projection plane to obtain a second projection point corresponding to each compensation reference point, that is, a three-dimensional coordinate of the compensation reference point is transformed into a two-dimensional coordinate. For example, the compensation reference point M and the compensation reference point N are projected onto the second preset projection plane respectively to obtain second projection points m and n. The computer device performs the linear fitting processing on the coordinate data of each second projection point to obtain a second fitting line, and performs the height compensation on the to-be-compensated measuring point through the second fitting line, that is, the coordinate data of the to-be-compensated measuring point is substituted into a second straight line equation corresponding to the second fitting line to obtain the height compensation value of the to-be-compensated measuring point, and then the height compensation is performed on the to-be-compensated measuring point through the height compensation value.

In the present embodiment, for the plurality of to-be-compensated measuring points obtained through the mobile sampling when the nozzle sprays the non-first layer of printing material, the first fitting line is determined through the adjacent measuring points corresponding to the to-be-compensated measuring point before the compensation reference point is determined according to the first fitting line, and then the height compensation for the to-be-compensated measuring point can be implemented according to the second projection point obtained by projecting the compensation reference point. Accordingly, the height compensation can be performed on each to-be-compensated measuring point in a targeted manner, thereby improving the accuracy of the height compensation for the printing platform.

It should be appreciated that, although the steps in the flowcharts involved in the above embodiments are displayed in sequence as indicated by the arrows, these steps are not definitely executed in the order indicated by the arrows. Unless otherwise specified herein, there is no strict order limitation for the execution of these steps, and these steps may be executed in other orders. Moreover, at least a part of the steps in the flowcharts involved in the above embodiments may include multiple steps or multiple stages. These steps or stages are not definitely executed at the same time, but can be executed at different time. These steps or stages are not definitely executed in sequence, but may be executed in turn or alternately with other steps or at least part of the steps or stages in other steps.

Based on the same inventive concept, in an embodiment of the present disclosure, a height compensation apparatus for implementing the above-mentioned height compensation method is provided. The solution to the problem provided by the apparatus is similar to that described in the above method, for the specific limitations in one or more embodiments of the height compensation apparatus provided below, reference can be made to the limitations on the height compensation method above, which will not be repeated here.

In an embodiment, as shown in FIG. 7, a height compensation apparatus 700 is provided, which includes: a mobile sampling module 702, a data fusion module 704, and a compensation value determination module 706.

The mobile sampling module 702 is configured to acquire a sampling result when a nozzle is controlled to spray a first layer of printing material along a printing platform and perform mobile sampling. The sampling result includes a first measured pressure value between the nozzle and the first layer of printing material, a second measured pressure value between the printing platform and the first layer of printing material, and an initial height value between the nozzle and the printing platform collected at a current sampling moment.

The data fusion module 704 is configured to perform data fusion processing on the first measured pressure value and the second measured pressure value, and obtain an actual pressure value at the current sampling moment.

The compensation value determination module 706 is configured to acquire a compensation model between a pressure value and a height compensation value, determine a target height compensation value corresponding to the actual pressure value according to the compensation model, and compensate for the initial height value between the nozzle and the printing platform collected at the current sampling moment according to the target height compensation value.

In an embodiment, the data fusion module 704 is further configured to perform the data fusion processing on the first measured pressure value and the second measured pressure value by using a Kalman filter algorithm, and obtain the actual pressure value at the current sampling moment.

In an embodiment, the compensation value determination module 706 is further configured to determine a historical actual pressure value at a previous sampling moment, determine a first difference value between the actual pressure value and a preset pressure threshold, determine a second difference value between the historical actual pressure value and the preset pressure threshold, and determine the target height compensation value corresponding to the actual pressure value according to the first difference value, the second difference value, and the compensation model.

In an embodiment, the compensation value determination module 706 is further configured to substitute the first difference value into a proportional sub-model to obtain a first height compensation value, obtain a second height compensation value according to the first difference value and an integral sub-model, substitute the first difference value and the second difference value into a differential sub-model to obtain a third height compensation value, and superimpose the first height compensation value, the second height compensation value, and the third height compensation value to obtain the target height compensation value.

In an embodiment, the compensation value determination module 706 is further configured to superimpose the first height compensation value, the second height compensation value and the third height compensation value to obtain a candidate height compensation value, determine the candidate height compensation value as the target height compensation value when a magnitude relationship between the preset compensation threshold and the candidate height compensation value satisfies a preset condition, and determine the preset compensation threshold as the target height compensation value when the magnitude relationship between the preset compensation threshold and the candidate height compensation value dissatisfies the preset condition.

In an embodiment, the height compensation apparatus 700 may further include a measuring point compensation module 708 configured to: determine a plurality of measuring points on the printing platform as a plurality of to-be-compensated measuring points when the nozzle is controlled to spray a non-first layer of printing material along the printing platform and perform the mobile sampling; determine a plurality of adjacent areas in positions adjacent to each to-be-compensated measuring point on the printing platform, in which each adjacent area includes at least two adjacent measuring points, and the adjacent measuring points are adjacent to the to-be-compensated measuring point among the plurality of measuring points; project at least two adjacent measuring points in each adjacent area onto a first preset projection plane and obtain coordinate data of at least two first projection points, perform linear fitting processing on the coordinate data of the at least two first projection points and obtain a first fitting line corresponding to each adjacent area; determine coordinate data of each compensation reference point according to the first fitting line corresponding to each adjacent area, the coordinate data of the at least two adjacent measuring points in each adjacent area, and the coordinate data of the to-be-compensated measuring point; project each compensation reference point onto a second preset projection plane and obtain coordinate data of each second projection point, and perform the height compensation on the coordinate data of the to-be-compensated measuring point according to the coordinate data of each second projection point.

The modules in the above-mentioned height compensation device can be fully or partially implemented by software, hardware or a combination thereof. The above modules may be embedded in or independent of a processor in a computer device in the form of hardware, or may be stored in a memory in a computer device in the form of software, so that the processor can invoke and execute operations corresponding to the above modules.

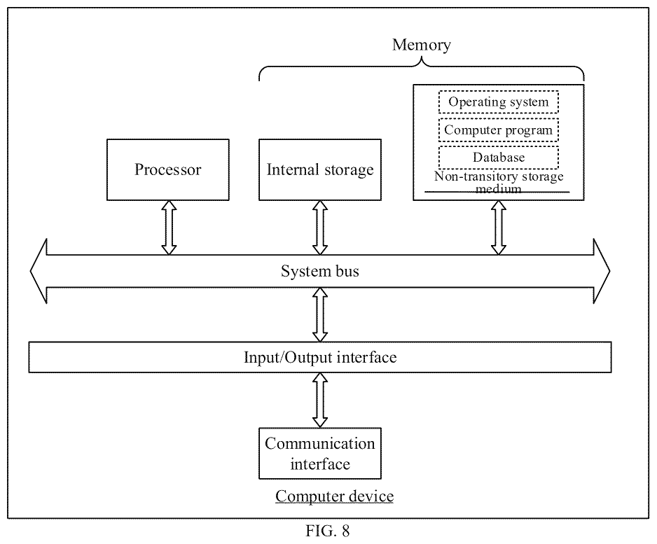

In an embodiment, a computer device is provided. The computer device may be a server, and an internal structure diagram thereof may be as shown in FIG. 8. The computer device includes one or more processors, a memory, an input/output (I/O for short) interface, and a communication interface. The one or more processors, the memory and the input/output interface are connected to each other through a system bus, and the communication interface is connected to the system bus through the input/output interface. The one or more processors of the computer device are configured to provide computing and control capabilities. The memory of the computer device may include one or more non-transitory storage media and an internal storage. The one or more non-transitory storage media store an operating system, computer-readable instructions, and a database. The internal storage provides an environment for the execution of the operating system and computer-readable instructions in one or more non-transitory storage media. The database of the computer device is configured to store height compensation data. The input/output interface of the computer device is configured to exchange information between one or more processors and an external device. The communication interface of the computer device is configured to communicate with an external terminal via a network connection. The computer-readable instructions are executed by one or more processors to implement a height compensation method for a printing platform.

Those skilled in the art may understand that the structure shown in FIG. 8 is merely a block diagram of a partial structure related to the solution of the present disclosure, and does not constitute a limitation on the computer device to which the solution of the present disclosure is applied. The specific computer device may include more or fewer components than shown in the figures, or combine certain components, or have a different arrangement of components.

In an embodiment, a computer device is further provided, which may include one or more processors and a memory storing computer-readable instructions. The one or more processors, when executing the computer-readable instructions, may implement the steps in the above-mentioned embodiments of the method.

In an embodiment, one or more computer-readable storage media are provided, on which computer-readable instructions are stored. The computer-readable instructions, when executed by one or more processors, may cause the one or more processors to implement the steps in the above-mentioned embodiments of the method.

In some embodiments, a computer program product is further provided, which may include computer-readable instructions. The computer-readable instructions, when executed by a processor, may cause the processor to implement the steps in the above-mentioned embodiments of the method.

A person of ordinary skill in the art can understand that all or part of the processes in the above-mentioned embodiment of the method can be implemented by instructing related hardware through computer-readable instructions. The computer-readable instructions can be stored in one or more non-transitory computer-readable storage media. When the computer-readable instructions are executed, the processes in the embodiments of the above-mentioned method are included. Any reference to a memory, a database, or other media used in the embodiments provided in the present disclosure may include at least one of a non-transitory memory and a transitory memory. The non-transitory memory may include a read-only memory (ROM), a magnetic tape, a floppy disk, a flash memory, an optical storage, a high-density embedded non-transitory memory, a resistive random access memory (ReRAM), a magnetoresistive random access memory (MRAM), a ferroelectric random access memory (FRAM), a phase change memory (PCM), a graphene memory, etc. The transitory memory may include a random access memory (RAM) or an external cache memory, etc. By way of illustration and not limitation, the RAM may be in various forms, such as a static random access memory (SRAM) or a dynamic random access memory (DRAM). The database involved in the embodiments provided in the present disclosure may include at least one of a relational database and a non-relational database. The non-relational database may include, but is not limited to, a distributed database based on a blockchain. The one or more processors involved in the embodiments provided in the present disclosure may be a general-purpose processor, a central processing unit, a graphics processor, a digital signal processor, a programmable logic unit, a data processing logic unit based on quantum computing, etc., but are not limited thereto.

The technical features of the above-described embodiments may be arbitrarily combined. In order to make the description concise, all possible combinations of the technical features in the above-described embodiments are not described. However, as long as there is no contradiction in the combinations of these technical features, these combinations should be considered to be within the scope of the present disclosure.

The technical features in the above embodiments can be combined in any way. To simplify the description, all possible combinations of the technical features in the above embodiments are not described. However, as long as there is no contradiction in the combination of these technical features, all possible combinations should be regarded as being within the scope of the present disclosure.

The above-described embodiments only express several implementation modes of the present disclosure, and the descriptions are relatively specific and detailed, but should not be construed as limiting the scope of the present disclosure. It should be noted that, those of ordinary skill in the art can make several modifications and improvements without departing from the concept of the present disclosure, and these all fall within the protection scope of the present disclosure. Therefore, the protection scope of the present disclosure should be subject to the appended claims.

1. A height compensation method, performed by a computer device, the method comprising:
acquiring a sampling result when a nozzle is controlled to spray a first layer of printing material along a printing platform and perform mobile sampling, wherein the sampling result comprises a first measured pressure value between the nozzle and the first layer of printing material, a second measured pressure value between the printing platform and the first layer of printing material, and an initial height value between the nozzle and the printing platform collected at a current sampling moment;
performing data fusion processing on the first measured pressure value and the second measured pressure value, and obtaining an actual pressure value at the current sampling moment;
acquiring a compensation model between a pressure value and a height compensation value;
determining a target height compensation value corresponding to the actual pressure value according to the compensation model; and
compensating for the initial height value between the nozzle and the printing platform collected at the current sampling moment according to the target height compensation value.

2. The method according to claim 1, wherein the first measured pressure value is detected by a first pressure sensor, and the second measured pressure value is detected by a second pressure sensor, the first pressure sensor is mounted on the nozzle, and the second pressure sensor is mounted on the printing platform.

3. The method according to claim 1, wherein the first measured pressure value comprises a first extrusion force on the nozzle applied by the first layer of printing material, and a pulling force on the nozzle applied by the first layer of printing material; the second measured pressure value comprises a second extrusion force on the printing platform applied by the first layer of printing material, and a gravity of the first layer of printing material.

4. The method according to claim 1, wherein performing the data fusion processing on the first measured pressure value and the second measured pressure value and obtaining the actual pressure value at the current sampling moment comprises:
performing the data fusion processing on the first measured pressure value and the second measured pressure value by using a Kalman filter algorithm, and obtaining the actual pressure value at the current sampling moment.

5. The method according to claim 1, wherein determining the target height compensation value corresponding to the actual pressure value according to the compensation model comprises:
determining a historical actual pressure value at a previous sampling moment;
determining a first difference value between the actual pressure value and a preset pressure threshold, and determining a second difference value between the historical actual pressure value and the preset pressure threshold;
determining the target height compensation value corresponding to the actual pressure value according to the first difference value, the second difference value, and the compensation model.

6. The method according to claim 5, wherein the compensation model comprises a proportional sub-model, an integral sub-model, and a differential sub-model;
wherein determining the target height compensation value corresponding to the actual pressure value according to the first difference value, the second difference value, and the compensation model comprises:
substituting the first difference value into the proportional sub-model to obtain a first height compensation value;
obtaining a second height compensation value according to the first difference value and the integral sub-model;
substituting the first difference value and the second difference value into the differential sub-model to obtain a third height compensation value;
superimposing the first height compensation value, the second height compensation value, and the third height compensation value to obtain the target height compensation value.

7. The method according to claim 6, wherein superimposing the first height compensation value, the second height compensation value, and the third height compensation value to obtain the target height compensation value comprises:
superimposing the first height compensation value, the second height compensation value and the third height compensation value to obtain a candidate height compensation value;
determining the candidate height compensation value as the target height compensation value when a magnitude relationship between the preset compensation threshold and the candidate height compensation value satisfies a preset condition;
determining the preset compensation threshold as the target height compensation value when the magnitude relationship between the preset compensation threshold and the candidate height compensation value dissatisfies the preset condition.

8. The method according to claim 7, wherein the preset condition includes that the candidate height compensation value is less than or equal to the preset compensation threshold.

9. The method according to claim 1, further comprising:
determine a plurality of measuring points on the printing platform as a plurality of to-be-compensated measuring points when the nozzle is controlled to spray a non-first layer of printing material along the printing platform and performing the mobile sampling;
determining a plurality of adjacent areas in positions adjacent to each to-be-compensated measuring point on the printing platform, wherein each adjacent area comprises at least two adjacent measuring points, and the adjacent measuring points are adjacent to each to-be-compensated measuring point among the plurality of measuring points;
projecting the at least two adjacent measuring points in each adjacent area onto a first preset projection plane, and obtaining coordinate data of at least two first projection points;
performing linear fitting processing on the coordinate data of the at least two first projection points, and obtaining a first fitting line corresponding to each adjacent area;
determining coordinate data of each compensation reference point according to the first fitting line corresponding to each adjacent area, coordinate data of the at least two adjacent measuring points in each adjacent area, and coordinate data of each to-be-compensated measuring point;
projecting each compensation reference point onto a second preset projection plane, and obtaining coordinate data of each second projection point;
performing the height compensation on the coordinate data of each to-be-compensated measuring point according to the coordinate data of each second projection point.

10. The method according to claim 9, wherein determining the plurality of adjacent areas in positions adjacent to each to-be-compensated measuring point on the printing platform comprises:
performing an adjacent area detection on each to-be-compensated measuring point, and determining adjacent areas in a preset direction as the adjacent areas corresponding to each to-be-compensated measuring point.

11. The method according to claim 9, wherein determining the coordinate data of each compensation reference point according to the first fitting line corresponding to each adjacent area, the coordinate data of the at least two adjacent measuring points in each adjacent area, and the coordinate data of each to-be-compensated measuring point comprises:
determining whether horizontal coordinate data of the at least two adjacent measuring points in each adjacent area are the same;
acquiring a first reference point determination model from a database when the horizontal coordinate data of the at least two adjacent measuring points are the same, wherein the first reference point determination model indicates that no coordinate transformation of the coordinate data of the adjacent measuring points is required;
substituting the coordinate data of the at least two adjacent measuring points and the coordinate data of each to-be-compensated measuring point into the first reference point determination model, and obtaining the coordinate data of each compensation reference point.

12. The method according to claim 11, further comprising:
acquiring a second reference point determination model from the database when the horizontal coordinate data of the at least two adjacent measuring points are different, wherein the second reference point determination model indicates that a right triangle needs to be constructed by using the coordinate data of the adjacent measuring points;
substituting the coordinate data of the at least two adjacent measuring points and the coordinate data of each to-be-compensated measuring point into the second reference point determination model, and obtaining the coordinate data of each compensation reference point.

13. A height compensation apparatus, comprising:
a mobile sampling module, configured to acquire a sampling result when a nozzle is controlled to spray a first layer of printing material along a printing platform and perform mobile sampling, wherein the sampling result comprises a first measured pressure value between the nozzle and the first layer of printing material, a second measured pressure value between the printing platform and the first layer of printing material, and an initial height value between the nozzle and the printing platform collected at a current sampling moment;
a data fusion module, configured to perform data fusion processing on the first measured pressure value and the second measured pressure value, and obtain an actual pressure value at the current sampling moment;
a compensation value determination module, configured to acquire a compensation model between a pressure value and a height compensation value, determine a target height compensation value corresponding to the actual pressure value according to the compensation model, and compensate for the initial height value between the nozzle and the printing platform collected at the current sampling moment according to the target height compensation value.

14. A computer device, comprising one or more processors and a memory storing computer-readable instructions, wherein the one or more processors, when executing the computer-readable instructions, implement the steps in the method of claim 1.

15. One or more computer-readable storage media, on which computer-readable instructions are stored, wherein the computer-readable instructions, when executed by one or more processors, cause the one or more processors to implement the steps in the method of claim 1.

16. The apparatus according to claim 13, wherein the data fusion module is further configured to perform the data fusion processing on the first measured pressure value and the second measured pressure value by using a Kalman filter algorithm, and obtain the actual pressure value at the current sampling moment.

17. The apparatus according to claim 13, wherein the compensation value determination module is further configured to determine a historical actual pressure value at a previous sampling moment, determine a first difference value between the actual pressure value and a preset pressure threshold, determine a second difference value between the historical actual pressure value and the preset pressure threshold, and determine the target height compensation value corresponding to the actual pressure value according to the first difference value, the second difference value, and the compensation model.

18. The apparatus according to claim 17, wherein the compensation value determination module is further configured to substitute the first difference value into a proportional sub-model to obtain a first height compensation value, obtain a second height compensation value according to the first difference value and an integral sub-model, substitute the first difference value and the second difference value into a differential sub-model to obtain a third height compensation value, and superimpose the first height compensation value, the second height compensation value, and the third height compensation value to obtain the target height compensation value.

19. The apparatus according to claim 18, wherein the compensation value determination module is further configured to superimpose the first height compensation value, the second height compensation value and the third height compensation value to obtain a candidate height compensation value, determine the candidate height compensation value as the target height compensation value when a magnitude relationship between the preset compensation threshold and the candidate height compensation value satisfies a preset condition, and determine the preset compensation threshold as the target height compensation value when the magnitude relationship between the preset compensation threshold and the candidate height compensation value dissatisfies the preset condition.

20. The apparatus according to claim 13, further comprising a measuring point compensation module configured to: determine a plurality of measuring points on the printing platform as a plurality of to-be-compensated measuring points when the nozzle is controlled to spray a non-first layer of printing material along the printing platform and perform the mobile sampling; determine a plurality of adjacent areas in positions adjacent to each to-be-compensated measuring point on the printing platform, wherein each adjacent area comprising at least two adjacent measuring points, and the adjacent measuring points are adjacent to each to-be-compensated measuring point among the plurality of measuring points; project at least two adjacent measuring points in each adjacent area onto a first preset projection plane and obtain coordinate data of at least two first projection points, perform linear fitting processing on the coordinate data of the at least two first projection points and obtain a first fitting line corresponding to each adjacent area; determine coordinate data of each compensation reference point according to the first fitting line corresponding to each adjacent area, the coordinate data of the at least two adjacent measuring points in each adjacent area, and the coordinate data of each to-be-compensated measuring point; project each compensation reference point onto a second preset projection plane and obtain coordinate data of each second projection point, and perform the height compensation on the coordinate data of each to-be-compensated measuring point according to the coordinate data of each second projection point.
